(19) United States
(12) Patent Application Publication
(10) Pub. No.: US 2025/0282581 A1
(43) Pub. Date: Sep. 11, 2025

(54) PIPE SLING

(71) Applicant: Rockwood Service Corporation, Tomball, TX (US)

(72) Inventor: Josh Suttles, Baton Rouge, LA (US)

(73) Assignee: Rockwood Service Corporation, Tomball, TX (US)

(21) Appl. No.: 18/601,358

(22) Filed: Mar. 11, 2024

(51) Int. Cl. B66C 1/18; F16L 1/06; F16L 3/137; F16L 3/26

(52) U.S. Cl. CPC B66C 1/18; F16L 1/06; F16L 3/137; F16L 3/26

(57) ABSTRACT

A pipe sling includes a fabric body section having a first axis of symmetry extending along a length of the fabric body section and a second axis of symmetry extending along a width of the fabric body section. A first set of securement devices are affixed to a first segment of the fabric body section defined by the second axis of symmetry. A second set of securement devices are affixed to a second segment of the fabric body section defined by the second axis of symmetry. At least one reinforcement element is positioned along the first axis of symmetry and extends from a first end of the fabric body section to a second end of the fabric body section.

### BACKGROUND

Damaged pipe removal is often a tedious process to carry out. Specifically, pipes that have questionable structural integrity, such as pipes that are corroded, thin-walled, and/or eroded, are delicate and thus become very cumbersome to move or transport. A common traditional means of removing a pipe from usage includes the choking of nylon slings from a crane at each end of the pipe with nothing along the length to brace the pipe in the case of a failure. When a long length of piping has corroded past its own structural limitations, shorter cuts of the pipe may have to be made to reduce the overall length of the pipe in order to support itself. This can result in more work being involved in a project such as, for example, additional cuts, additional stripping of insulation (if required), additional lifts utilizing the crane, and additional asbestos abatement work. This work will raise the overall cost of the project and increase overall exposure hours.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1A is an illustration of an exterior view of a pipe sling in an open configuration in accordance with certain embodiments of the present disclosure;

FIG. 1B is a photo of an exterior view of a pipe sling in an open configuration in accordance with certain embodiments of the present disclosure;

FIG. 1C is an illustration of a perspective view of the pipe sling of FIG. 1A in a secured position in accordance with certain embodiments of the present disclosure; and

FIG. 2 is an illustration of a perspective view of the pipe sling of FIG. 1A being suspended from a lifting device while supporting a pipe in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present invention relates generally to slings, and more particularly to slings for lifting pipes out of the ground. The term “safe working load” or “SWL” is used herein to describe a maximum safe force that a piece of lifting equipment, lifting device, or accessory can exert to lift, suspend, or lower, a given mass without fear of breaking.

By virtue of utilizing embodiments of a pipe sling as disclosed, in regards to a pipe, additional structural support can be added, capture or encapsulation support can be provided in the event of failure, and average overall length (of 12 feet from cut to cut) can be maintained. This can reduce the overall scope of the work, reducing the cost of the project and make the project safer by reducing exposure hours and preventing lift failures. Alternatively, certain client policies are to remove insulation from carbon steel piping and perform an inspection of pipe before removing, regardless of the integrity. Utilizing the disclosed embodiments of the sling can eliminate the inspection/removal steps of the project, shortening the duration and reducing the cost of the project overall.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit. Further, although voltage signals discussed herein are discussed as positive voltages, a negative voltage signal or differential voltage signal may be generated, used, or detected without departing from the scope of the present invention.

Presented herein is a pipe sling. The pipe sling comprises a fabric body section, including a first axis of symmetry extending along a length of the fabric body section and a second axis of symmetry extending along a width of the fabric body section. A first set of securement devices are affixed to a first segment of the fabric body section defined by the second axis of symmetry. A second set of securement devices are affixed to a second segment of the fabric body section defined by the second axis of symmetry. At least one reinforcement element is positioned along the first axis of symmetry and extends from a first end of the fabric body section to a second end of the fabric body section.

Also presented herein is a system for transporting pipes comprising a lifting device and a pipe sling suspended from the lifting device and wrapped around a diameter of a pipe. The pipe sling comprises a fabric body section comprising a first axis of symmetry extending along a length of the fabric body section and a second axis of symmetry extending along a width of the fabric body section. A first set of securement devices affixed to a first segment of the fabric body section are defined by the second axis of symmetry, where a first quantity of the first set of securement devices are secured to the lifting device and a second quantity of the first set of securement devices are wrapped around and secured to the fabric body section and the pipe. A second set of securement devices affixed to a second segment of the fabric body section are defined by the second axis of symmetry, where a first quantity of the second set of securement devices are removably affixed to the lifting device and a second quantity of the second set of securement devices are wrapped around and secured to the fabric body section and the pipe. At least one reinforcement element positioned along the first axis of symmetry extends from a first end of the fabric body section to a second end of the fabric body section. The at least one reinforcement element is configured to reduce sag of the fabric body section when the pipe sling is wrapped around the pipe while secured to the lifting device.

Also presented herein is a pipe sling for supporting a pipe. The pipe sling comprises a nylon canvas fabric body section comprising a first axis of symmetry extending along a length of the fabric body section and a second axis of symmetry extending along a width of the fabric body section, where the width of the fabric body section ranges from 24 inches to 36 inches. A first set of securement devices affixed to a first segment of the fabric body section are defined by the second axis of symmetry and a second set of securement devices affixed to a second segment of the fabric body section are defined by the second axis of symmetry. Each of the first set of securement devices and each of the second set of securement devices extend across the width of the fabric body section and are stitched to the fabric body section along the first axis of symmetry, where the first set of securement devices and the second set of securement devices include at least four eye to eye nylon lifting straps spaced between at least four ratchet straps. At least one reinforcement element comprising at least one metal segment extends along an entirety of the first axis of symmetry from a first end of the fabric body section to a second end of the fabric body section, where the at least one reinforcement element is configured to reduce sag of the fabric body section when the pipe sling is being lifted with a pipe. A safe working load (SWL) of the pipe sling, when lifting the pipe, ranges from 3,000 pounds to 4,500 pounds.

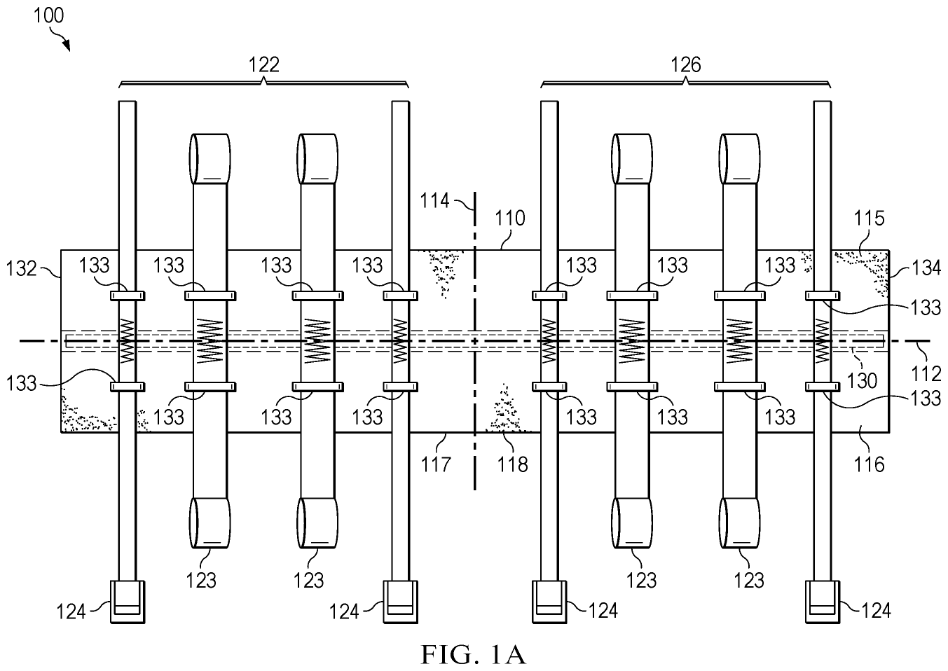

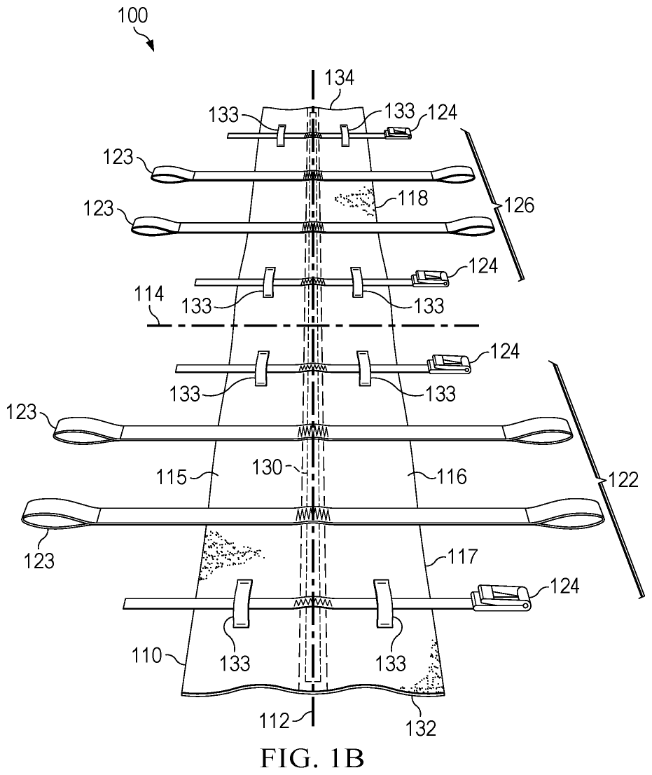

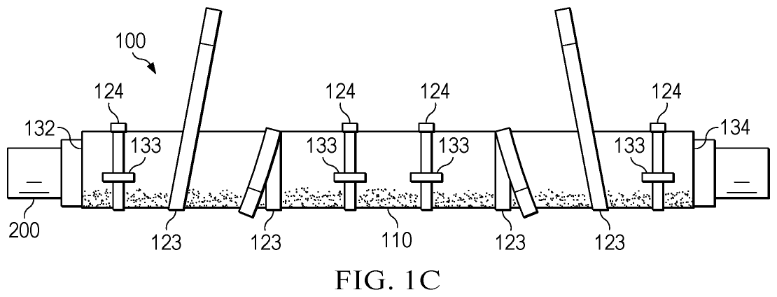

FIG. 1A is an illustration of an exterior view of a pipe sling 100 in an open position in accordance with certain embodiments of the present disclosure. Pipe sling 100 comprises a fabric body section 110, where, in embodiments, is a nylon canvas fabric. The fabric body section 110 includes an exterior surface area, an interior surface area (for contact with a pipe), a first axis of symmetry 112 extending along a length of the fabric body section 110, and a second axis of symmetry 114 extending along a width of the fabric body section 110. First axis of symmetry 112 may segment fabric body section 110 into first and second (upper and lower) segments 115,116, while second axis of symmetry 114 may also segment fabric body section 110 into first and second (left and right) segments 117,118. A first set of securement devices 122 are affixed to segment 117 defined by second axis of symmetry 114. The first set of securement devices 122 include a pair of lifting straps 123 positioned between a pair of ratchet straps 124. A second set of securement devices 126 symmetrical to the first set of securement devices 122 (in relation to the second axis of symmetry 114) are affixed to segment 118 and also include a pair of lifting straps 123 positioned between a pair of ratchet straps 124. The (four) ratchet straps 124 are positioned to effectively tighten fabric sling body section 110 of pipe sling 100 around a pipe while minimizing slippage and securing insulation (if needed) around the pipe. This may prevent/reduce the potential of the pipe slipping out of the pipe sling 100/being dropped.

As further shown in FIG. 1A, each of the first set of securement devices 122 and each of the second set of securement devices 126 extend across the width of the fabric body section 110 and are secured (stitched) to exterior surface area of fabric body section 110 along the first axis of symmetry 112. In order to keep the first and second set of securement devices 122,124 properly aligned across the width of the fabric body section 110, each of the first set of securement devices 122 and each of the second set of securement devices 124 are positioned through a pair of guide loops 133, where each of the pair of guide loops 133 are positioned equidistant from the first axis of symmetry 112. In certain embodiments, first and second guide loops of a pair of guide loops 133 of each of the securement devices of the first set and second set of securement devices are positioned 12 inches from a second guide loop of each of the pair of guide loops 133 of the first set of securement devices 124 and the second set of securement devices 126. By virtue of the loop configurations, a secure foundation is provided to pipes being transported by pipe sling 100.

In an embodiment, each of the first set of securement devices 122 and each of the second set of securement devices 126 are secured (stitched) to fabric body section 110 adjacent edges of first and second (upper and lower) segments 115,116.

When a pipe 200 is positioned on/within pipe sling 100, such as the embodiment shown in FIG. 1B, lifting straps 123 are configured to attach to a lifting device (or to an adapter configured to attach to a lifting device) for transport of the pipe 200 while ratchet straps 124 are configured to wrap around pipe 200 and secure pipe 200 within fabric body section 110. In order to reduce sag/sagging of the fabric body section 110 when pipe sling 100 is being lifted with a pipe 200, at least one reinforcement element 130 is positioned along the first axis of symmetry 112. The at least one reinforcement element 130, as shown, includes a one inch metal segment and extends from a first end 132 of the fabric body section 110 to a second end 134 of the fabric body section 110. Additionally, in embodiments, the at least one reinforcement element 130 is sewn between fabric body section 110 and another piece of fabric (such as, for example, a webbing). In an embodiment, the at least one reinforcement element 130 includes two one inch metal segments that are sewn between fabric body section 110 and another piece of fabric that extend from a first end 132 of the fabric body section 110 to a second end 134 of the fabric body section 110. In a further embodiment, the at least one reinforcement element 130 comprises carbon steel.

In an embodiment, in the case where the at least one reinforcement element 130 is sewn between fabric body section 110 and another piece of fabric (such as, for example, a webbing), multiple pieces of webbing may be utilized in order to securely encapsulate one or more reinforcement elements 130 to fabric body section 110.

FIG. 1C is an illustration of a perspective view of the pipe sling 100 of FIG. 1A in a secured position accordance with certain embodiments of the present disclosure. As shown, pipe sling 100 is wrapped around and secured to a pipe 200. In order to secure pipe sling 100 to pipe 200, a plurality of ratchet straps 124 (as shown, four ratchet straps) are positioned equidistantly from second axis of symmetry 114. When pipe 200 is positioned within pipe sling 100, strap portions of ratchet straps 124 are wrapped around pipe 200 and pipe sling 100. Ends of the strap portions are fed through ratchet portions of the ratchet straps 124 until the ratchet straps 124 are tightly secured to/around pipe 200 and pipe sling 100.

As further shown, the two outermost lifting straps 123 are shown in an engageable position and are each configured to receive a transitionary receiver device (such as, for example, a shackle) when in this position. The two innermost lifting straps 123 are shown in a disengageable position and folded over themselves. If additional support is needed toward the center of pipe sling 100, the innermost lifting straps 123 can be engageable in a similar fashion as the two outermost lifting straps 123.

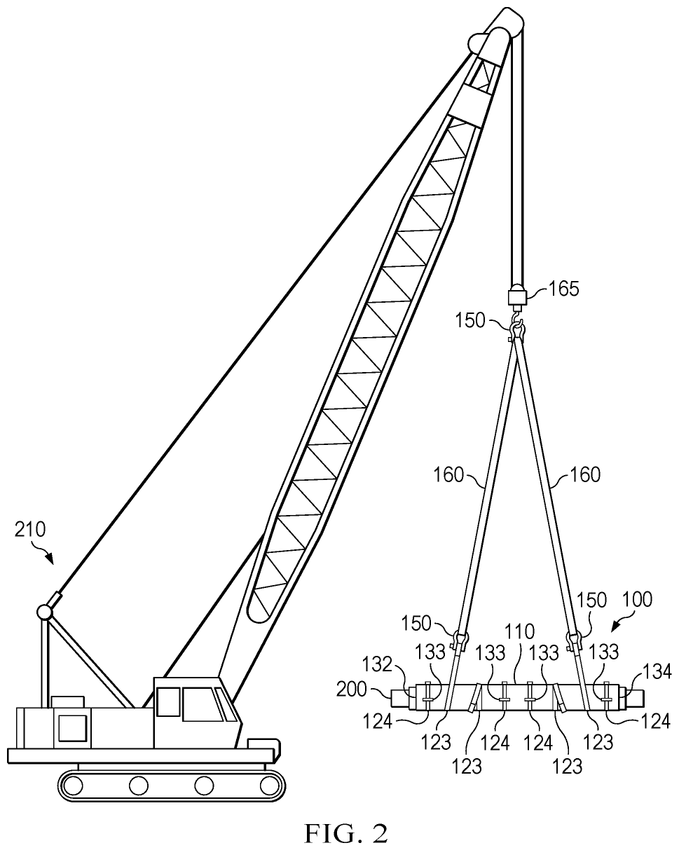

FIG. 2 is an illustration of a perspective view of the pipe sling 100 of FIG. 1A being suspended from a lifting device 210 (as shown, for example, a crane) while supporting a pipe 200 in accordance with certain embodiments of the present disclosure. As shown, a portion of the outermost lifting straps 123 are positioned around fabric body section 110 and pipe 200 while looped ends of the outermost lifting straps 123 are engaged with a pair of shackles 150 attached to upper lifting straps 160 (or, in other embodiments, wire rope) suspended from a shackle 150 secured to a crane hook 165 of lifting device 210 so that pipe sling 100 and pipe 200 are suspended from lifting device 210. Prior to pipe sling 100 being suspended from lifting device 210, ratchet straps 124 are tightened securely around pipe 200 to be moved/transported. In instances where pipe sling 100 is utilized to move/transport pipes having asbestos insulation, these pipes can be safely and securely moved/transported. Utilizing pipe sling 100 in the enclosed configuration as shown can eliminate a step of prepping an asbestos-lined pipe for transportation purposes. In an embodiment, lifting device 210 may comprise a come along device. As previously presented, if additional support is needed toward the center of pipe sling 100, the innermost lifting straps 123 can be engageable in a similar fashion as the two outermost lifting straps 123. It is noted that at least shackles 150 and upper lifting straps 160 may be referred to as “rigging” for attaching pipe sling 100 and pipe 200 to lifting device 210. In embodiments, “rigging” may attach to the two innermost lifting straps 123 only, the two outermost lifting straps 123 only, or to all four (or more, in embodiments) lifting straps 123. In the case where all lifting straps 123 are to be engaged, multiple sets of equipment “rigging” may be utilized to engage all lifting straps 123. For example, a first set of equipment rigging may engage the two innermost lifting straps 123 and connect the two innermost lifting straps 123 to a first lifting device 210 while a second set of equipment rigging may engage the two outermost lifting straps 123 and connect the two outermost lifting straps 123 to a second lifting device 210.

Generally, pipe sling 100 is configured to assist in the moving and/or transport of pipes having a diameter of ½ inch to 12 inches and a length of no greater than 12 feet. In order to move and/or transport the pipes, pipe sling 100, in embodiments, may comprise a fabric body section 110 having a width ranging from 24 inches to 36 inches and a length of 10 feet.

In embodiments, four lifting straps 123 may be rigged (using rigging as described above, for example) to a single lifting device 210 for the lifting of pipe sling 100 and a pipe. In other embodiments, a first set/pair of lifting straps 123 (one positioned on upper segment 115 and one positioned on lower segment 116) may be rigged to a single lifting device 210 while the second set/pair of lifting straps 123 may be rigged to an additional lifting device 210 (or may be engaged by one or more individuals). The second set/pair of lifting straps 123 may be engaged in order to maneuver pipe sling 100 and the pipe, via the additional lifting device 210, around obstacles that may be in the way/in the lifting path of pipe sling 100 and the pipe. The obstacles may include, but are not limited to: pipes, pipe rack structures, wires, and electrical cables. It is noted that the second set/pair of lifting straps 123 may engage a lifting device 210 before lifting of the pipe sling 100 and pipe or during the process of lifting if it is discovered that there are obstacles in the lifting path of pipe sling 100 and pipe. In additional embodiments, during the lifting process if/when obstacles get in the way of the lifting path of the pipe sling 100 and pipe, the first set/pair of lifting straps 123 may be disengaged from pipe sling 100 and pipe and the second set/pair of lifting straps 123 may be engaged to pipe sling 100 and pipe; this may enable maneuverability of the pipe sling 100 and pipe around the obstacles (via a lifting device 210) and may maintain points of attachment to pipe sling 100. Generally, additional tie-off points are created when pipe sling 100 includes four lifting straps 123. In additional embodiments, the aforementioned rigging configurations may be carried out when there are more or less than four lifting straps 123.

In an embodiment, a pipe sling 100 is provided that is configured to support a pipe having a diameter ranging from ½ inch to 6 inches. Pipe sling 200 comprise a nylon canvas fabric body section 110 including a first axis of symmetry 112 extending along a length (in embodiments, 10 feet) of the fabric body section 110 and a second axis of symmetry 114 extending along a width (in embodiments, 24 inches) of the fabric body section 110. A first set of securement devices 122 are affixed to a first (left) segment 117 of the fabric body section 110 defined by the second axis of symmetry 114 and a second set of securement devices 126 affixed to a second (right) segment 118 of the fabric body section 110 defined by the second axis of symmetry 114, where each of the first set of securement devices 122 and each of the second set of securement devices 126 extend across the width of the fabric body section 110 and are stitched to the fabric body section 110 along the first axis of symmetry 112. The first set of securement devices 122 and the second set of securement devices 126 include four eye to eye nylon lifting straps 123 (in embodiments, 1 inch by 6 feet, 2 ply) spaced between four ratchet straps 124. A reinforcement element 130 includes a 1 inch metal segment extending along an entirety of the first axis of symmetry 112 from a first end 132 of the fabric body section 110 to a second end 134 of the fabric body section 110, where the reinforcement element 130 is configured to reduce sag of the fabric body section 110 when the pipe sling 100 is being lifted with a pipe. It is noted that the pipe sling 100 described above is certified to embody a safe working load (SWL)/rated capacity of 3,000 pounds. The certification is based at least on the following: Federal Specification RR-W-410D, ASME B30.9, API 9A, API 9B, API 2D, the Wire Rope Technical Board's “Wire Rope User's User, the Wire Rope Technical Board's “Wire Rope Sling User's Manual”, and the Occupational Safety and Health Administration's “Industrial Slings”.

In an embodiment, a pipe sling 100 is provided that is configured to support a pipe having a diameter ranging from 6 inches to 12 inches. Pipe sling 200 comprise a nylon canvas fabric body section 110 including a first axis of symmetry 112 extending along a length (in embodiments, 10 feet) of the fabric body section 110 and a second axis of symmetry 114 extending along a width (in embodiments, 36 inches) of the fabric body section 110. A first set of securement devices 122 are affixed to a first (left) segment 117 of the fabric body section 110 defined by the second axis of symmetry 114 and a second set of securement devices 126 affixed to a second (right) segment 118 of the fabric body section 110 defined by the second axis of symmetry 114, where each of the first set of securement devices 122 and each of the second set of securement devices 126 extend across the width of the fabric body section 110 and are stitched to the fabric body section 110 along the first axis of symmetry 112. The first set of securement devices 122 and the second set of securement devices 126 include four eye to eye nylon lifting straps 123 (in embodiments, 2 inches by 6 feet, 2 ply) spaced between five ratchet straps 124. At least one reinforcement element 130 includes two 1 inch metal segments extending along an entirety of the first axis of symmetry 112 from a first end 132 of the fabric body section 110 to a second end 134 of the fabric body section 110, where the at least one reinforcement element 130 is configured to reduce sag of the fabric body section 110 when the pipe sling 100 is being lifted with a pipe. It is noted that the pipe sling 100 described above is certified to embody a safe working load (SWL)/rated capacity of 4,500 pounds. The certification is based at least on the following: Federal Specification RR-W-410D, ASME B30.9, API 9A, API 9B, API 2D, the Wire Rope Technical Board's “Wire Rope User's User, the Wire Rope Technical Board's “Wire Rope Sling User's Manual”, and the Occupational Safety and Health Administration's “Industrial Slings”.

For the purposes of this disclosure, the term “lifting device” may refer to any device, unit, mechanism, or combination thereof, which is configured and is capable of lifting and moving the pipe when the pipe is housed in any embodiment of pipe sling 100 disclosed. For example, a “lifting device” may include, but is not limited to: a hoist (automatic and/or manual), a crane, and a helicopter.

It is noted that the configuration of pipe sling 100 disclosed may eliminate the need for end caps for pipes. In the case where fabric body section 110 is longer in length than a pipe wrapped in fabric body section 110, ends of a pipe are covered and protected by fabric body section 110.

In any of the embodiments disclosed, the first set of securement devices 122 and the second set of securement devices 126 include at least four eye to eye nylon lifting straps 123 spaced between at least four ratchet straps 124.

In any of the embodiments disclosed, pipe sling 100 includes at least one reinforcement element 130 including at least one metal segment extending along an entirety of the first axis of symmetry 112 from a first end 132 of the fabric body section 110 to a second end 134 of the fabric body section 110.

In any of the embodiments disclosed, lifting straps 123 may each comprise two loops (one at each end of strap 123) for engagement with a lifting device. In another embodiment, lifting straps 123 may each comprise four loops (two at each end of strap 123) for engagement with a lifting device. In another embodiment, lifting straps 123 may each comprise up to ten loops (five at each end of strap 123) for engagement with a lifting device. In further embodiments, the entirety of lifting straps 123 and/or the loops comprise a two ply configuration.

In any of the embodiments disclosed, pipe sling 100 is configured to be utilized with either of a horizontal lifting device or a vertical lifting device.

In embodiments, pipe sling 100 is configured to support/move/transport a pipe having a maximum length of 12 feet.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a pipe sling comprising: a fabric body section, the fabric body section comprising a first axis of symmetry extending along a length of the fabric body section and a second axis of symmetry extending along a width of the fabric body section; a first set of securement devices affixed to a first segment of the fabric body section defined by the second axis of symmetry; a second set of securement devices affixed to a second segment of the fabric body section defined by the second axis of symmetry; and at least one reinforcement element positioned along the first axis of symmetry and extending from a first end of the fabric body section to a second end of the fabric body section.

The pipe sling of Clause 1, wherein the fabric body section comprises nylon canvas fabric.

The pipe sling of Clause 1, wherein the width of the fabric body section ranges from 24 inches to 36 inches.

The pipe sling of Clause 1, wherein each of the at least one reinforcement element comprises a metal segment.

The pipe sling of Clause 1, wherein each of the first set of securement devices and each of the second set of securement devices extend across the width of the fabric body section.

The pipe sling of Clause 5, wherein each of the first set of securement devices and each of the second set of securement devices are stitched to the fabric body section along the first axis of symmetry.

The pipe sling of Clause 1, wherein each of the first set of securement devices and each of the second set of securement devices are positioned through a pair of guide loops, each of the pair of guide loops positioned equidistant from the first axis of symmetry.

The pipe sling of Clause 7, wherein a first guide loop of each of the pair of guide loops of the first set of securement devices and the second set of securement devices are positioned 12 inches from a second guide loop of each of the pair of guide loops of the first set of securement devices and the second set of securement devices.

The pipe sling of Clause 1, wherein the first set of securement devices and the second set of securement devices each comprise a pair of lifting straps positioned between a pair of ratchet straps.

The pipe sling of Clause 1, wherein the at least one reinforcement element is configured to reduce sag of the fabric body section when the pipe sling is being lifted with a pipe.

Clause 11, a system for transporting pipes, comprising: a lifting device; and a pipe sling suspended from the lifting device and wrapped around a diameter of a pipe, the pipe sling comprising: a fabric body section, the fabric body section comprising a first axis of symmetry extending along a length of the fabric body section and a second axis of symmetry extending along a width of the fabric body section; a first set of securement devices affixed to a first segment of the fabric body section defined by the second axis of symmetry, wherein a first quantity of the first set of securement devices are secured to the lifting device and a second quantity of the first set of securement devices are wrapped around and secured to the fabric body section and the pipe; a second set of securement devices affixed to a second segment of the fabric body section defined by the second axis of symmetry, wherein a first quantity of the second set of securement devices are removably affixed to the lifting device and a second quantity of the second set of securement devices are wrapped around and secured to the fabric body section and the pipe; and at least one reinforcement element positioned along the first axis of symmetry and extending from a first end of the fabric body section to a second end of the fabric body section; wherein the at least one reinforcement element is configured to reduce sag of the fabric body section when the pipe sling is wrapped around the pipe while secured to the lifting device.

Clause 12, the pipe sling of Clause 1, wherein the fabric body section comprises nylon canvas fabric.

Clause 13, the system of Clause 11, wherein the width of the fabric body section ranges from 24 inches to 36 inches.

Clause 14, the system of Clause 11, wherein each of the at least one reinforcement element comprises a metal segment.

Clause 15, the system of Clause 11, wherein each of the first set of securement devices and each of the second set of securement devices extend across the width of the fabric body section.

Clause 16, the system of Clause 15, wherein each of the first set of securement devices and each of the second set of securement devices are stitched to the fabric body section along the first axis of symmetry.

Clause 17, the pipe sling of Clause 11, wherein each of the first set of securement devices and each of the second set of securement devices are positioned through a pair of guide loops, each of the pair of guide loops positioned equidistant from the first axis of symmetry.

Clause 18, the pipe sling of Clause 17, wherein a first guide loop of each of the pair of guide loops of the first set of securement devices and the second set of securement devices are positioned 12 inches from a second guide loop of each of the pair of guide loops of the first set of securement devices and the second set of securement devices.

Clause 19, the pipe sling of Clause 11, wherein the first set of securement devices and the second set of securement devices each comprise a pair of lifting straps positioned between a pair of ratchet straps.

Clause 20, a pipe sling for supporting a pipe, comprising: a nylon canvas fabric body section, the fabric body section comprising a first axis of symmetry extending along a length of the fabric body section and a second axis of symmetry extending along a width of the fabric body section, the width of the fabric body section ranging from 24 inches to 36 inches; a first set of securement devices affixed to a first segment of the fabric body section defined by the second axis of symmetry and a second set of securement devices affixed to a second segment of the fabric body section defined by the second axis of symmetry, each of the first set of securement devices and each of the second set of securement devices extending across the width of the fabric body section and stitched to the fabric body section along the first axis of symmetry, the first set of securement devices and the second set of securement devices including at least four eye to eye nylon lifting straps spaced between at least four ratchet straps; and at least one reinforcement element comprising at least one metal segment extending along an entirety of the first axis of symmetry from a first end of the fabric body section to a second end of the fabric body section, the at least one reinforcement element configured to reduce sag of the fabric body section when the pipe sling is being lifted with a pipe; wherein a safe working load (SWL) of the pipe sling, when lifting the pipe, ranges from 3,000 pounds to 4,500 pounds.

What is claimed is:

1. A pipe sling comprising:
a fabric body section, the fabric body section comprising a first axis of symmetry extending along a length of the fabric body section and a second axis of symmetry extending along a width of the fabric body section;
a first set of securement devices affixed to a first segment of the fabric body section defined by the second axis of symmetry;
a second set of securement devices affixed to a second segment of the fabric body section defined by the second axis of symmetry; and
at least one reinforcement element positioned along the first axis of symmetry and extending from a first end of the fabric body section to a second end of the fabric body section.

2. The pipe sling of claim 1, wherein the fabric body section comprises nylon canvas fabric.

3. The pipe sling of claim 1, wherein the width of the fabric body section ranges from 24 inches to 36 inches.

4. The pipe sling of claim 1, wherein each of the at least one reinforcement element comprises a metal segment.

5. The pipe sling of claim 1, wherein each of the first set of securement devices and each of the second set of securement devices extend across the width of the fabric body section.

6. The pipe sling of claim 5, wherein each of the first set of securement devices and each of the second set of securement devices are stitched to the fabric body section along the first axis of symmetry.

7. The pipe sling of claim 1, wherein each of the first set of securement devices and each of the second set of securement devices are positioned through a pair of guide loops, each of the pair of guide loops positioned equidistant from the first axis of symmetry.

8. The pipe sling of claim 7, wherein a first guide loop of each of the pair of guide loops of the first set of securement devices and the second set of securement devices are positioned 12 inches from a second guide loop of each of the pair of guide loops of the first set of securement devices and the second set of securement devices.

9. The pipe sling of claim 1, wherein the first set of securement devices and the second set of securement devices each comprise a pair of lifting straps positioned between a pair of ratchet straps.

10. The pipe sling of claim 1, wherein the at least one reinforcement element is configured to reduce sag of the fabric body section when the pipe sling is being lifted with a pipe.

11. A system for transporting pipes, comprising:
a lifting device; and
a pipe sling suspended from the lifting device and wrapped around a diameter of a pipe, the pipe sling comprising:
a fabric body section, the fabric body section comprising a first axis of symmetry extending along a length of the fabric body section and a second axis of symmetry extending along a width of the fabric body section;
a first set of securement devices affixed to a first segment of the fabric body section defined by the second axis of symmetry, wherein a first quantity of the first set of securement devices are secured to the lifting device and a second quantity of the first set of securement devices are wrapped around and secured to the fabric body section and the pipe;
a second set of securement devices affixed to a second segment of the fabric body section defined by the second axis of symmetry, wherein a first quantity of the second set of securement devices are removably affixed to the lifting device and a second quantity of the second set of securement devices are wrapped around and secured to the fabric body section and the pipe; and
at least one reinforcement element positioned along the first axis of symmetry and extending from a first end of the fabric body section to a second end of the fabric body section;
wherein the at least one reinforcement element is configured to reduce sag of the fabric body section when the pipe sling is wrapped around the pipe while secured to the lifting device.

12. The pipe sling of claim 1, wherein the fabric body section comprises nylon canvas fabric.

13. The system of claim 11, wherein the width of the fabric body section ranges from 24 inches to 36 inches.

14. The system of claim 11, wherein each of the at least one reinforcement element comprises a metal segment.

15. The system of claim 11, wherein each of the first set of securement devices and each of the second set of securement devices extend across the width of the fabric body section.

16. The system of claim 15, wherein each of the first set of securement devices and each of the second set of securement devices are stitched to the fabric body section along the first axis of symmetry.

17. The pipe sling of claim 11, wherein each of the first set of securement devices and each of the second set of securement devices are positioned through a pair of guide loops, each of the pair of guide loops positioned equidistant from the first axis of symmetry.

18. The pipe sling of claim 17, wherein a first guide loop of each of the pair of guide loops of the first set of securement devices and the second set of securement devices are positioned 12 inches from a second guide loop of each of the pair of guide loops of the first set of securement devices and the second set of securement devices.

19. The pipe sling of claim 11, wherein the first set of securement devices and the second set of securement devices each comprise a pair of lifting straps positioned between a pair of ratchet straps.

20. A pipe sling for supporting a pipe, comprising:
a nylon canvas fabric body section, the fabric body section comprising a first axis of symmetry extending along a length of the fabric body section and a second axis of symmetry extending along a width of the fabric body section, the width of the fabric body section ranging from 24 inches to 36 inches;
a first set of securement devices affixed to a first segment of the fabric body section defined by the second axis of symmetry and a second set of securement devices affixed to a second segment of the fabric body section defined by the second axis of symmetry, each of the first set of securement devices and each of the second set of securement devices extending across the width of the fabric body section and stitched to the fabric body section along the first axis of symmetry, the first set of securement devices and the second set of securement devices including at least four eye to eye nylon lifting straps spaced between at least four ratchet straps; and
at least one reinforcement element comprising at least one metal segment extending along an entirety of the first axis of symmetry from a first end of the fabric body section to a second end of the fabric body section, the at least one reinforcement element configured to reduce sag of the fabric body section when the pipe sling is being lifted with a pipe;
wherein a safe working load (SWL) of the pipe sling, when lifting the pipe, ranges from 3,000 pounds to 4,500 pounds.
